(19) United States
(12) Patent Application Publication
(10) Pub. No.: US 2015/0235667 A1
(43) Pub. Date: Aug. 20, 2015

(54) ROTATING DEVICE

(71) Applicant: SAMSUNG ELECTRO-MECHANICS JAPAN ADVANCED TECH. CO. LTD., Fuijeda City (JP)

(72) Inventor: Ryusuke SUGIKI, Fujieda City (JP)

(73) Assignee: SAMSUNG ELECTRO-MECHANICS JAPAN ADVANCED TECH. CO. LTD., Fujieda City (JP)

(21) Appl. No.: 14/618,826

(22) Filed: Feb. 10, 2015

(30) Foreign Application Priority Data
Feb. 14, 2014 (JP) 2014-026942

(51) Int. Cl. G11B 19/20; F16C 33/74; F16C 32/06

(52) U.S. Cl. CPC G11B 19/2036; F16C 32/0633; F16C 33/745

(57) ABSTRACT

A rotating device includes: a rotating body supported in a freely rotatable manner relative to a stationary body; a retaining gap retaining a lubricant; a fluid dynamic pressure generating portion generating dynamic pressure to the fluid; a capillary seal in communication with a first end of the retaining gap, and extending toward an external side from the retaining gap; a cap including an annular cover portion that covers at least a part of an end of the capillary seal located at the external side from the retaining gap, and, a cylindrical portion that extends from an outer circumference of the cover portion in an axial direction; and an annular groove including an annular first wall that encircles the cylindrical portion, an annular second wall that is encircled by the cylindrical portion, and a bottom wall that faces an end of the cylindrical portion opposite to the cover portion.

### BACKGROUND OF THE INVENTION

1. Field of the Invention

The present disclosure relates to a rotating device.

2. Description of the Related Art

Disk drive devices like hard disk drives that are a type of rotating devices employ a fluid dynamic bearing which has a fluid applied between a rotating body and a stationary body, and which holds a recording disk in a freely rotatable manner.

According to this structure, when the lubricant is dispersed from the gap between the rotating body and the stationary body and sticks to the surface of the recording disk, it may cause an operation failure like a data read/write error of the recording-disk. Hence, in order to prevent the lubricant from sticking to the recording disk, a structure which covers, by a cap, the gap between the rotating body and the stationary body where the lubricant is applied has been proposed (see, for example, JP 2009-136143 A and JP 2011-2024 A).

Although this structure is employed, there is still a possibility that the lubricant is dispersed from the gap between the cap and the stationary body, reaches a disk retaining space, and sticks to the recording disk, causing an operation failure. Therefore, a further sure reduction of the lubricant that is dispersed to the disk retaining space is desired.

The present disclosure has been made in view of the aforementioned circumstances, and it is an objective of the present disclosure to provide a rotating device that can further reduce the possibility of an operation failure caused by the dispersion of a lubricant.

### SUMMARY OF THE INVENTION

A rotating device according to a first aspect of the present disclosure includes:

a stationary body;

a rotating body that is supported in a freely rotatable manner relative to the stationary body;

a retaining gap that retains a lubricant between the stationary body and the rotating body;

a fluid dynamic pressure generating portion that generates dynamic pressure to the fluid in the retaining gap;

a capillary seal which is in communication with a first end of the retaining gap, and which extends toward an external side from the retaining gap;

a cap provided on the stationary body, the cap including an annular cover portion that covers at least a part of an end of the capillary seal which is located at the external side from the retaining gap, and, a cylindrical portion that extends from an outer circumference of the cover portion in an axial direction which is in parallel with a rotation axis of the rotating body; and

an annular groove provided in the rotating body, the annular groove including an annular first wall that encircles the cylindrical portion via a first gap, an annular second wall that is encircled by the cylindrical portion via a second gap, and a bottom wall that faces, via a third gap in the axial direction, an end of the cylindrical portion opposite to the cover portion.

A rotating device according to a second aspect of the present disclosure includes:

a stationary body;

a rotating body that is supported in a freely rotatable manner relative to the stationary body;

a retaining gap that retains a lubricant between the stationary body and the rotating body;

a fluid dynamic pressure generating portion that generates dynamic pressure to the fluid in the retaining gap;

a capillary seal which is in communication with a first end of the retaining gap, and which extends toward an external side from the retaining gap; and

a cap provided on the stationary body, the cap including an annular cover portion that covers at least a part of an end of the capillary seal which is located at the external side from the retaining gap, and, a cylindrical portion that extends from an outer circumference of the cover portion in an axial direction which is in parallel with a rotation axis of the rotating body, in which:

the rotating body includes an annular first wall that encircles the cylindrical portion via a first gap, an annular second wall that is encircled by the cylindrical portion via a second gap, and a bottom wall that faces, via a third gap in the axial direction, an end of the cylindrical portion opposite to the cover portion; and

the first gap, the second gap, and the third gap are in communication with each other, and form a bent labyrinth.

A rotating device according to a third aspect of the present disclosure includes:

a stationary body;

a rotating body that is supported in a freely rotatable manner relative to the stationary body;

a retaining gap that retains a lubricant between the stationary body and the rotating body;

a fluid dynamic pressure generating portion that generates dynamic pressure to the fluid in the retaining gap;

a capillary seal which is in communication with a first end of the retaining gap, and which extends toward an external side from the retaining gap; and

a cap provided on the stationary body, the cap including an annular cover portion that covers at least a part of an end of the capillary seal which is located at the external side from the retaining gap, and, a cylindrical portion that extends from an outer circumference of the cover portion in an axial direction which is in parallel with a rotation axis of the rotating body,

in which:

the rotating body includes an annular first wall that encircles the cylindrical portion via a first gap, an annular second wall that is encircled by the cylindrical portion via a second gap, and a bottom wall that faces, via a third gap in the axial direction, an end of the cylindrical portion opposite to the cover portion;

the first gap decreases a gap width toward the bottom wall in the axial direction; and

the second gap decreases a gap width toward an opposite side to the bottom wall in the axial direction.

### BRIEF DESCRIPTION OF THE DRAWINGS

FIGS. 1A to 1C are diagrams each illustrating an example structure of a rotating device according to a first embodiment;

FIG. 2 is a cross-sectional view illustrating an example bearing mechanism in the rotating device of the first embodiment;

FIG. 3 is an enlarged diagram illustrating an example structure including a first gas-liquid interface according to the first embodiment;

FIG. 4 is an enlarged diagram illustrating a modified example of the structure including the first gas-liquid interface of the first embodiment;

FIG. 5 is an enlarged diagram illustrating an example structure including a tapered gap of the first embodiment;

FIG. 6 is a cross-sectional view illustrating an example bearing mechanism of a rotating device according to a second embodiment; and

FIG. 7 is an enlarged diagram illustrating an example structure including a first gas-liquid interface of the second embodiment.

### DETAILED DESCRIPTION OF THE PREFERRED EMBODIMENTS

Embodiments to carry out the present disclosure will be explained below with reference to the figures. The same structural element in respective figures will be denoted by the same reference numeral, and the duplicated explanation will be omitted. The dimension of a component in each figure will be enlarged or scaled down as needed to facilitate understanding to the present disclosure. In addition, a part of a component not important to explain the embodiments will be omitted in the figures.

A rotating device according to embodiments to be explained below can be utilized as a disk drive device like a hard disk drive on which a recording disk that magnetically records data is to be mounted, and which rotates the recording disk.

### First Embodiment

[Structure of Rotating Device]

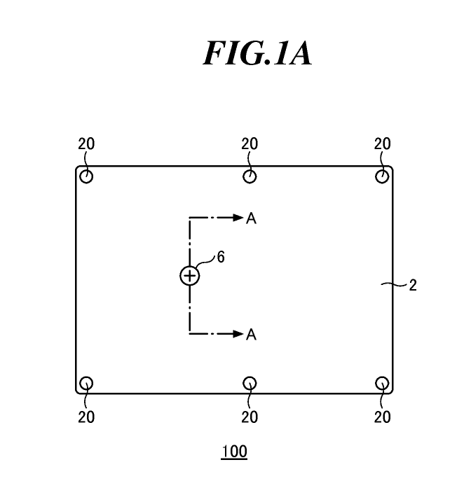

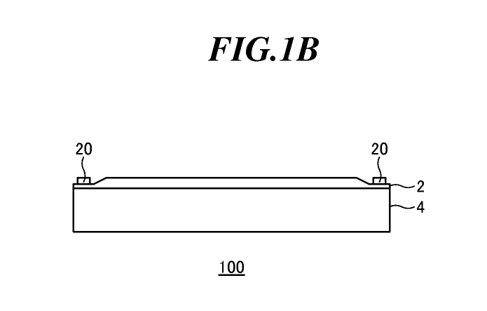

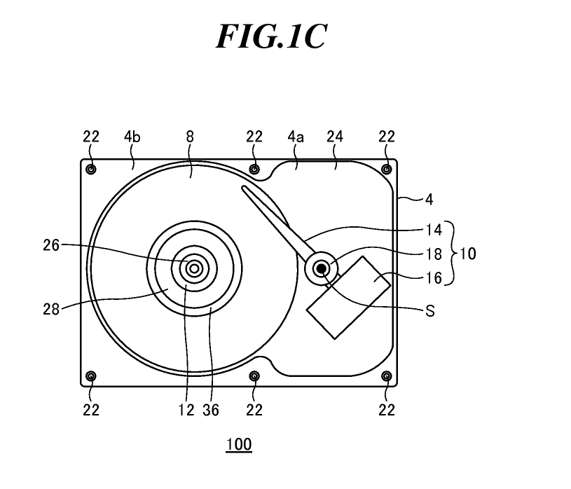

FIGS. 1A to 1C illustrate an example rotating device 100 according to a first embodiment, and an explanation will be first given of the whole structure of the rotating device 100. FIG. 1A is a top view of the rotating device 100, FIG. 1B is a side view of the rotating device 100, and FIG. 1C is a top view of the rotating device 100 having a top cover 2 detached.

The rotating device 100 includes the top cover 2, a base 4, recording disks 8, a data reader/writer 10, a cap 12, a shaft 26, a hub 28, and a clamper 36.

In the following explanation, with the top cover 2 being attached to the base 4, a top-cover-2 side will be defined as an upper side, while a base-4 side will be defined as a lower side. In addition, a direction in parallel with the rotation axis of the recording disk 8 will be defined as an axial direction, and an arbitrary direction passing through the rotation axis on a plane orthogonal to the rotation axis will be defined as a radial direction. In the radial direction, a side distant from the rotation axis will be defined as an outer circumference, while a side near the rotation axis will be defined as an inner circumference. Those notations do not limit the posture of the applied rotating device 100, and the rotating device 100 can be applied in an arbitrary posture.

(Top Cover)

The top cover 2 is formed by, for example, pressing an aluminum sheet or a steel sheet. A surface finishing like plating may be applied to the top cover 2 to suppress corrosion.

The top cover 2 is fixed to the upper face of the base 4 by peripheral screws 20. The top cover 2 and the base 4 are fixed together so as to air-tightly seal the interior of the rotating device 100. A fastener screw 6 inserted in the center hole of the top cover 2 is screwed in a fastener screw hole of the shaft 26 that is fixed to the base 4.

(Base)

The base 4 includes a bottom plate 4a that forms the bottom of the rotating device 100, and an outer circumference wall 4b that is formed along the outer circumference of the bottom plate 4a so as to encircle the mount area of the recording disks 8. Screw holes 22 in which the respective peripheral screws 20 are screwed are provided in the upper face of the outer circumference wall 4b.

The upper face of the outer circumference wall 4b of the base 4 is fixed with the top cover 2 by the peripheral screws 20. A disk retaining space 24 surrounded by the bottom plate 4a of the base, the outer circumference wall 4b thereof, and the top cover 2 is air-tightly sealed and blocked off from the external environment, and is filled with a clean gas having dusts, etc., eliminated. Hence, a sticking of foreign materials like dusts to the recording disks 8 can be suppressed, and thus the possibility that causes the operation failure of the rotating device 100 is reduced.

The base 4 is formed by, for example, die-casting using an aluminum alloy, or pressing of a sheet metal like stainless-steel or aluminum. When pressing is employed, embossing that forms convexities on the upper side of the base 4 may be applied. When embossing is applied to predetermined locations, a deformation of the base 4 can be suppressed.

In addition, the base 4 may include a plating layer formed of a metal, such as nickel or chromium, or a coating layer formed of a resin material like an epoxy resin. According to such a surface finishing, a surface peeling of the base 4 can be suppressed. Moreover, at the time of, for example, manufacturing, when the recording disk 8, etc., contacts the surface of the base 4, the possibility that the surface of the base 4 and that of the recording disks 8, etc., are damaged can be reduced. Further, in comparison with the coating layer formed of a resin material, the plating layer can enhance the surface hardness of the base 4, and reduce the friction coefficient. Hence, the possibility that the surface of the base 4 and that of the recording disk 8, etc., are damaged due to a contact can be further reduced.

(Data Reader/Writer)

The data reader/writer 10 includes an unillustrated recording/playing head, a swing arm 14, a voice coil motor 16, and a pivot assembly 18. The recoding/playing head is attached to the tip of the swing arm 14, records data in the magnetic recording disk 8, or reads the data therefrom. The pivot assembly 18 supports the swing arm 14 in a swingable manner around a head rotating axis S. The voice coil motor 16 allows the swing arm 14 to swing around the head rotating axis S to move the recording/playing head to a desired location over the top face of the magnetic recording disk 8. The voice coil motor 16 and the pivot assembly 18 are configured by a conventionally well-known technology of controlling the position of a head.

(Recording Disk)

The recording disks 8 are each a 3.5-inch recording disk which is formed of a glass and has a diameter of 95 mm. The diameter of the center hole is 25 mm, and the thickness is 1.27 mm. The recording disks 8 are mounted on the outer periphery of the hub 28.

[Structure of Bearing Mechanism]

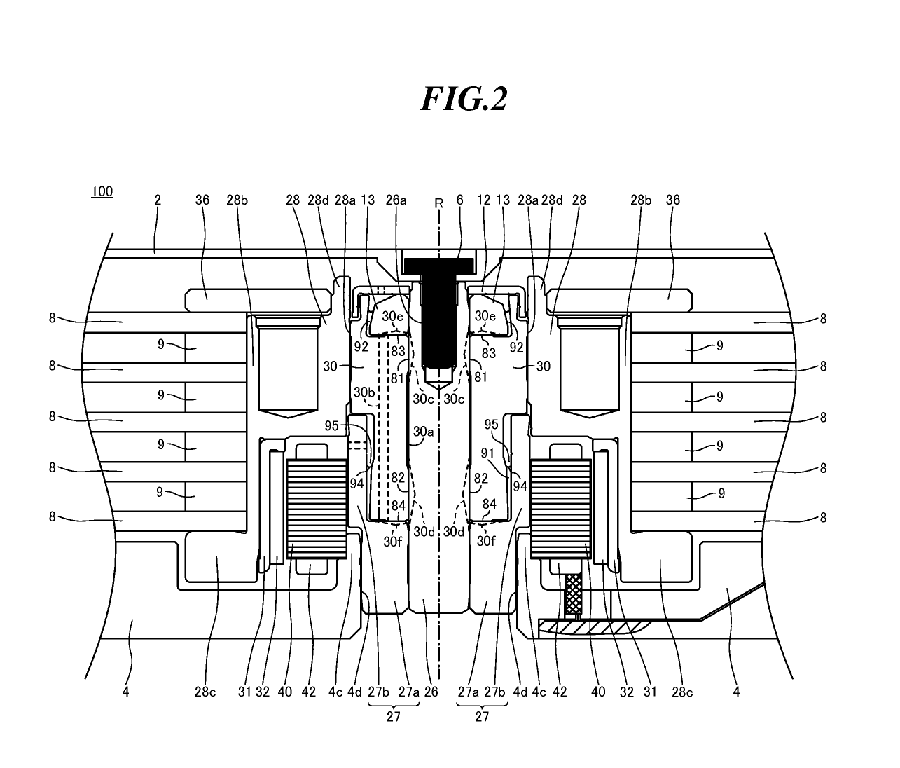

FIG. 2 is a cross-sectional view taken along aline A-A in FIG. 1A, and is a cross-sectional view illustrating an example bearing mechanism of the rotating device 100 according to the first embodiment.

The rotating device 100 includes, as stationary body components, the base 4, the cap 12, a top flange 13, the shaft 26, a housing 27, a stator core 40, and coils 42. In addition, the rotating device 100 includes, as rotating body components, the hub 28, a sleeve 30, a yoke 31, a magnet 32, and the clamper 36.

A predetermined amount of lubricant 92 is applied to predetermined gaps between the sleeve 30, the top flange 13, the shaft 26, and the housing 27 in the rotating device 100, and the rotating body that includes the hub 28 on which the recording disks 8 are to be mounted is supported in a manner freely rotatable relative to the stationary body that includes the shaft 26 around a rotation axis R.

(Sleeve)

The sleeve 30 is formed of, for example, a ferrous material like SUS 430 (a kind of stainless-steel, the same is true of the following notations) in a substantially cylindrical shape by cutting and machining. In addition, the sleeve 30 may be formed by cutting and machining a ferrous material like SUS 430 or a metal like brass to which a surface finishing like electroless nickel plating is applied after the cutting and machining.

The sleeve 30 encircles the shaft 26 that is fitted in a shaft hole 30a, and is supported in a freely rotatable manner around the rotation axis R relative to the top flange 13, the shaft 26, and the housing 27. A retaining gap 91 is formed between the sleeve 30 and the top flange 13, the shaft 26, the housing 27, and, the retaining gap 91 retains the lubricant 92 applied therein. In this embodiment, the lubricant 92 is continuously applied from one gas-liquid interface to another gas-liquid interface in the retaining gap 91.

The sleeve 30 includes a communication passage 30b formed along the axial direction so as to cause the gap with the top flange 13 to be in communication with the gap with the housing 27. The communication passage 30b reduces the pressure difference applied to the lubricant 92 in the retaining space 91 that retains the lubricant 92, thereby stabilizing the rotation of the sleeve 30 and that of the hub 28.

(Hub)

The hub 28 is formed by, for example, cutting and machining or pressing a ferrous material like SUS 430 in a substantially cup shape. A surface finishing like electroless nickel plating may be applied to the surface of the hub 28 so as to suppress a peeling of fine residues sticking to the processed surface.

The hub 28 includes a sleeve hole 28a into which the sleeve 30 is fitted, an engage portion 28b to be engaged with the center hole of the recording disk 8, and a mount portion 28c that has an upper face on which the recording disk 8 is to be mounted. The hub 28 is fixed to the sleeve 30 fitted in the sleeve hole 28a, and is supported in a freely rotatable manner together with the sleeve 30 relative to the stationary body that includes the shaft 26 and the housing 27.

The recording disks 8 each have the center hole 28 into which the engage portion 28b of the hub 28 is fitted, and are held between the clamper 36 and the mount portion 28c in a manner superimposed with each other with a spacer 9 being present between the adjoining recording disks 8, and thus the recording disks 8 are rotatable together with the hub 28.

The hub 28 and the sleeve 30 may be formed as separate components as explained in this embodiment, or may be formed integrally with each other as a single component.

(Clamper)

The clamper 36 is formed by, for example, cutting and machining or pressing a ferrous material like SUS 303 (a kind of stainless-steel, the same is true of the following notations) in a hollow disk shape. The clamper 36 has the center hole engaged with a protruding portion 28d that protrudes from the upper face of the hub 28, has the lower face abutting the upper face of the uppermost recording disk 8, and fastens the recording disks 8 to the mount portion 28c of the hub 28 together with the spacers 9.

(Yoke)

The yoke 31 is formed by cutting and machining or pressing, for example, a ferrous material with soft magnetism in a cylindrical shape. The yoke 31 is fixed to the inner circumference of the engage portion 28b of the hub 28 by, for example, bonding.

(Magnet)

The magnet 32 is formed in a cylindrical shape, and is fixed to the inner circumference of the yoke 31 by, for example, bonding. The magnet 32 is formed of, for example, a ferrite-based magnetic material or a rare-earth magnetic material. The magnet 32 contains a resin like polyamide as a binder. The magnet 32 may be formed by laminating a ferrite-based magnetic layer and a rare-earth magnetic layer.

The magnet 32 is provided with, for example, 12 magnetic poles in the circumferential direction of the inner circumference, and those magnetic poles face the outer circumferences of the salient poles of the stator core 40 in the radial direction with respective gaps.

(Stator Core)

The stator core 40 includes an annular portion, and multiple salient poles that extend from the annular portion outwardly in the radial direction. The stator core 40 is fixed to the outer circumference of a projection 4c projecting cylindrically from the bottom of the base 4 by, for example, press-fitting. The stator core 40 can be formed by, for example, laminating and caulking multiple thin magnetic steel sheets together. An insulation coating, such as electrodeposition coating or powder coating, is applied to the surface of the stator core 40. The coil 42 is wound around each salient pole of the stator core 40, and when three-phase substantially sinusoidal drive currents are caused to flow through the coils 42, drive magnetic fluxes are generated along the respective salient poles. Note that the stator core 40 may be a solid core formed by solidifying magnetic powders in a predetermined shape like a sintered body.

(Shaft)

The shaft 26 is formed by, for example, cutting and machining a ferrous material like SUS 420 J2 (a kind of stainless-steel, the same is true of the following notations), and is provided with a fastener screw hole 26a at the upper end portion in parallel with the rotation axis R. The shaft 26 is fitted in the shaft hole 30a of the sleeve 30, and has the upper end portion fixed to the top cover 2 by the fastener screw 6 inserted in the fastener screw hole 26a. In addition, the shaft 26 has the lower end portion fixed and supported by the housing 27.

The upper end portion of the shaft 26 is provided with the top flange 13 that protrudes circularly in the radial direction from the outer circumference of the shaft 26. The top flange 13 is fixed to the upper end portion of the shaft 26 by, for example, press-fitting, bonding or a combination thereof.

Note that the shaft 26 and the top flange 13 may be separate components as explained in this embodiment, or may be formed and integrated with each other as a single component.

(Housing)

The housing 27 is formed by cutting and machining a ferrous material like SUS 430 or a metal like brass. The housing 27 includes a supporting portion 27a that fixes and supports the lower end portion of the shaft 26, and a sleeve encircling portion 27b that encircles the lower end portion of the sleeve 30. The housing 27 is inserted in and fixed to a center hole 4d of the base 4 by, for example, press-fitting, bonding or a combination thereof.

(Lubricant)

The retaining gap 91 that is formed between the sleeve 30 and the top flange 13, the shaft 26, the housing 27 retains the lubricant 92 applied as a fluid. The lubricant 92 has a fluorescent material added to the base oil, and when the lubricant 92 is leaking from a predetermined gap between the components, the leakage can be easily detected upon emission of light with a predetermined wavelength.

(Dynamic Pressure Generating Portions)

Formed in the gap where the outer circumference of the shaft 26 and the inner circumference of the shaft hole 30a of the sleeve 30 face with each other in the radial direction are a first radial dynamic pressure generating portion 81 at the upper side, and a second radial dynamic pressure generating portion 82 at the lower side. The first and second radial dynamic pressure generating portions 81, 82 are spaced apart from each other in the axial direction.

First radial dynamic pressure generating grooves 30c which are in a herringbone shape or a spiral shape, etc., are formed in the inner circumference of the shaft hole 30a of the sleeve 30 corresponding to the first radial dynamic pressure generating portion 81. In addition, second radial dynamic pressure generating grooves 30d which are in a herringbone shape or a spiral shape, etc., are formed in the inner circumference of the shaft hole 30a of the sleeve 30 corresponding to the second radial dynamic pressure generating portion 82. Either one of or both of the first and second radial dynamic pressure generating grooves 30c, 30d may be formed in the outer circumference of the shaft 26.

Provided in a gap between the upper face of the sleeve 30 and the lower face of the top flange 13 is a first thrust dynamic pressure generating portion 83. In addition, provided in a gap between the lower face of the sleeve 30 and the upper face of the supporting portion 27a of the housing 27 is a second thrust dynamic pressure generating portion 84.

First thrust dynamic pressure generating grooves 30e which are in a herringbone shape or in a spiral shape are formed in the upper face of the sleeve 30 corresponding to the first thrust dynamic pressure generating portion 83. In addition, second thrust dynamic pressure generating grooves 30f which are in a herringbone shape or in a spiral shape are formed in the lower face of the sleeve 30 corresponding to the second thrust dynamic pressure generating portion 84. The first thrust dynamic pressure generating grooves 30e may be provided in the lower face of the top flange 13, and the second thrust dynamic pressure generating grooves 30f may be provided in the upper face of the supporting portion 27a of the housing 27.

When the rotating body that includes the sleeve 30 and the hub 28 rotates relative to the stationary body that includes the shaft 26, the top flange 13, and the housing 27, dynamic pressures are generated in the lubricant 92 at the first and second radial dynamic pressure generating portions 81, 82, and the first and second thrust dynamic pressure generating portions 83, 84, respectively. The sleeve 30 is supported in the axial direction and in the radial direction in a non-contact manner with the shaft 26, the top flange 13, and the housing 27 by the dynamic pressures generated in the lubricant 92, and rotates together with the hub 28.

The first and second radial dynamic pressure generating grooves 30c, 30d, and the first and second thrust dynamic pressure generating grooves 30e, 30f can be formed by, for example, pressing, ball rolling, electro chemical machining, or cutting and machining that control the position of the processing tool by piezo elements, etc., but those grooves can be formed by different techniques.

(Sealing Structure for Lubricant)

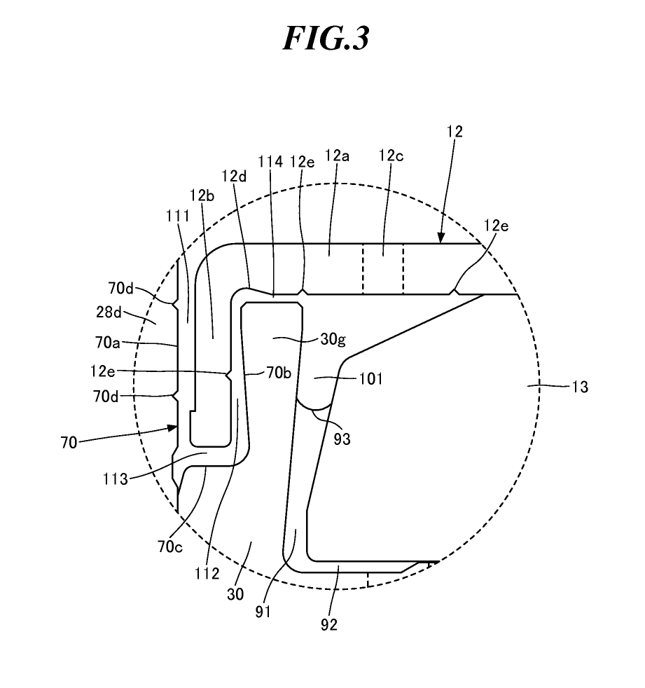

FIG. 3 is an enlarged diagram illustrating an example structure that includes a first gas-liquid interface 93 of the lubricant 92.

As illustrated in FIG. 3, the lubricant 92 is retained in the retaining gap 91 between the top flange 13 and the sleeve 30. The sleeve 30 includes a top-flange encircling portion 30g which protrudes annularly from the upper face, and which encircles the top flange 13. The first gas-liquid interface 93 of the lubricant 92 is formed between the inner circumference of the top-flange encircling portion 30g and the outer circumference of the top flange 13.

The top flange 13 includes a tapered face which is formed on the outer circumference thereof, and which increases the radius toward the downward side in the axial direction. In addition, the top-flange encircling portion 30g of the sleeve 30 includes a tapered face which is formed on the inner circumference thereof, and which gradually increases the radius toward the downward side in the axial direction in comparison with the tapered face of the top flange 13. According to such a structure, a tapered space 101 which is in communication with the retaining space 91, and which decreases the gap width toward the retaining space 91 (toward the downward side in the axial direction) is formed between the outer circumference of the top flange 13 and the inner circumference of the top-flange encircling portion 30g of the sleeve 30.

In the tapered space 101, force is applied to, by a capillary phenomenon, the lubricant 92 toward the downward side at which the gap width decreases, and thus the lubricant 92 is held between the top flange 13 and the top-flange encircling portion 30g of the sleeve 30. That is, the tapered space 101 functions as a capillary seal (sometimes called a tapered seal).

As illustrated in FIG. 2, the annular cap 12 that covers the gap between the top flange 13 and the sleeve 30 is provided on the upper end portion of the shaft 26. The cap 12 has a center hole into which the upper end portion of the shaft 26 is inserted, and has the lower face provided so as to abut the upper face of the top flange 13. The cap 12 is fixed to the shaft 26 and the top flange 13 by, for example, press-fitting, bonding or a combination thereof. The cap 12 is formed by cutting and machining of a ferrous material, such as SUS 303 or SUS 430. The cap 12 may be formed of a resin material, such as a PBT (polybutylene terephthalate) resin or a POM (polyxymethylene) resin.

As illustrated in FIG. 3, the cap 12 includes an annular cover portion 12a that covers the tapered space 101, and a cylindrical portion 12b that extends downwardly from the outer circumference of the cover portion 12a. The cap 12 has a diameter of, for example, 11 mm, and has a center hole of 3.5 mm. The cover portion 12a has a thickness of, for example, 0.5 mm in the axial direction, and the cylindrical portion 12b has a thickness of, for example, 0.35 mm in the radial direction.

An annular groove 70 where the cylindrical portion 12b of the cap 12 enters is formed between the top-flange encircling portion 30g of the sleeve 30 and the protruding portion 28d of the hub 28. The annular groove 70 includes a first wall 70a, a second wall 70b, and a bottom wall 70c. The first wall 70a encircles the cylindrical portion 12b of the cap 12 via a first gap 111. The second wall 70b is encircled by the cylindrical portion 12b of the cap 12 via a second gap 112. The bottom wall 70c faces the cylindrical portion 12b of the cap 12 via a third gap 113. The first gap 111, the second gap 112, and the third gap 113 from a bent labyrinth that is in communication with the tapered space 101. The bottom wall 70c may simply be a boundary between the first wall 70a and the second wall 70b.

The cap 12 has the cover portion 12a covering the tapered space 101, thereby catching the lubricant 92 dispersed from the first gas-liquid interface 93, and prevents the dispersed lubricant 92 from reaching the disk retaining space 24. In addition, the cap 12 forms a labyrinth by the cylindrical portion 12b together with the annular groove 70, thereby further surely preventing the dispersed lubricant 92 from reaching the disk retaining space 24.

A fourth gap 114 is formed between the lower face of the cover portion 12a of the cap 12 and the upper face of the top-flange encircling portion 30g of the sleeve 30. A tapered face 12d that increases the distance from the upper face of the top-flange encircling portion 30g of the sleeve 30 outwardly in in the radial direction is formed in the lower face of the cover portion 12a of the cap 12 at a portion where the fourth gap 114 is formed.

According to such a structure, even if, for example, the lubricant 92 is dispersed to and reaches the fourth gap 114, force is applied to, by a capillary phenomenon, the lubricant 92 at the inner circumference side at which the gap width decreases. Hence, the lubricant 92 is held in the fourth gap 114.

In addition, the top-flange encircling portion 30g of the sleeve 30 includes a tapered face which is formed on the outer circumference thereof, and which increases the radius toward the upper side in the axial direction, and thus the second gap 112 is formed so as to decrease the gap width toward the upper side. According to such a structure, even if, for example, the lubricant 92 is dispersed to and reaches the second gap 112, force is applied to, by a capillary phenomenon, the lubricant 92 toward the upper side at which the gap width decreases. Hence, the lubricant 92 is held in the second gap 112.

In this case, example dimensions of the respective portions will be explained. It is preferable that the first gap 111 should have a gap width of, for example, 100 to 500 μm in the radial direction, and more preferably, 100 to 300 μm. In addition, it is preferable that the third gap should have a gap width of, for example, 50 to 400 μm in the axial direction, and more preferably, 50 to 200 μm.

It is preferable that the second gap should have a gap width of, for example, 20 to 300 μm in the radial direction, and more preferably, 20 to 150 μm.

It is preferable that the fourth gap 114 should have a gap width of, for example, 10 to 300 μm in the axial direction, and more preferably, 10 to 120 μm.

An annular recess 12e around the rotation axis R is formed in the lower face of the cover portion 12a of the cap 12 and the inner circumference of the cylindrical portion 12b. In addition, an annular recess 70d around the rotation axis R is also formed in the first wall 70a of the annular groove 70. The recesses 12e, 70d each have a depth of, for example, 50 μm, hold the lubricant 92 dispersed from the first gas-liquid interface 93 and sticking to those recesses, thereby preventing the lubricant 92 from dispersing to and reaching the disk retaining space 24 through the fourth gap 114 to the first gap 111. Needless to say, the position, the number, and the depth of the recesses are not limited to the above-explained examples in this embodiment. The recess maybe also formed in the second wall 70b of the annular groove 70 and the bottom wall 70c, etc.

An oil repellent agent is applied to the cap 12 so as to reflect the lubricant 92 dispersed from the first gas-liquid interface 93. The oil repellent agent may be partially applied to, for example, the lower face of the cover portion 12a of the cap 12, or may be applied entirely.

The cover portion 12a of the cap 12 is provided with a through-hole 12c. The through-hole 12c causes the tapered space 101 to be in communication with the upper space of the cap 12. Hence, pressure applied to the lubricant 92 can be reduced, enabling the retaining gap 91 to further stably retain the lubricant 92.

According to such a structure, the lubricant 92 is prevented from being dispersed to and reaching the disk retaining space 24 by the tapered space 101, the labyrinth formed from the first gap 111 to the third gap 113, the sealing function of the second gap 112 and that of the fourth gap 114, and the recesses 12e, 70d, etc.

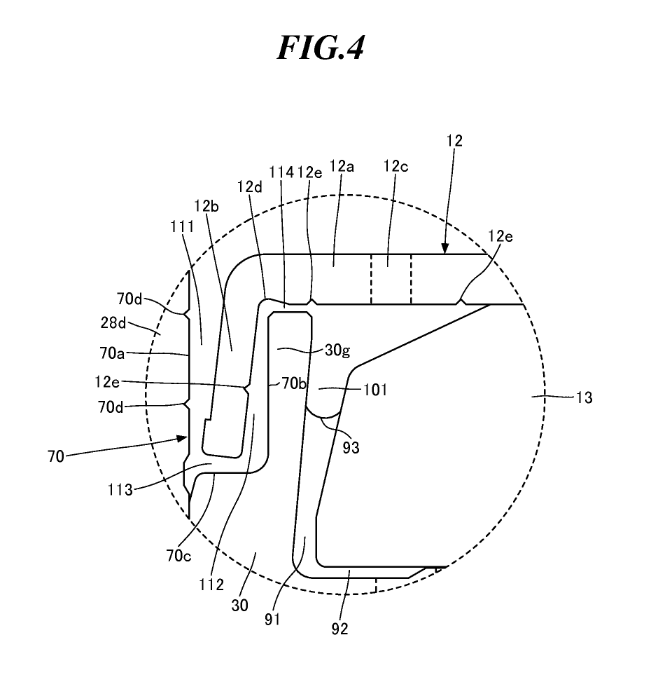

As is exemplified in FIG. 4, the cap 12 may have the cylindrical portion 12b spreading toward the downward side in the axial direction in a manner inclined relative to the axial direction. When the cylindrical portion 12b of the cap 12 is inclined as exemplified in FIG. 4, the first gap 111 is formed so as to decrease the gap width toward the downward side in the axial direction. According to this structure, when, for example, the lubricant 92 is dispersed to and reaches the first gap 111, force is applied to, by a capillary phenomenon, the lubricant 92 toward the downward side at which the gap width decreases. Hence, the lubricant 92 is held in the first gap 111.

In addition, the second gap 112 is formed so as to decrease the gap width toward the upper side in the axial direction, and thus the effect of trapping the dispersed lubricant 92 like the structure exemplified in FIG. 3 can be accomplished. In this case, the second wall 70b of the annular groove 70 may have no tapered face.

According to the structure exemplified in FIG. 4, since the first gap 111 has the sealing function in addition to those of the second and fourth gaps 112, 114, a dispersion of the lubricant 92 to the disk retaining space 24 can be further suppressed. In addition, it becomes unnecessary to form a tapered face on the second wall 70b of the annular groove 70. Hence, a dispersion of the lubricant 92 can be suppressed by a simpler structure.

Next, a sealing structure for a second gas-liquid interface 94 of the lubricant 92 will be explained below.

As illustrated in FIG. 2, the second gas-liquid interface 94 of the lubricant 92 is formed between the outer circumference of the lower end portion of the sleeve 30 and the inner circumference of the sleeve encircling portion 27b of the housing 27. The outer circumference of the lower end portion of the sleeve 30 is formed with a tapered face that decreases the radius toward the upper side in the axial direction, and thus a sealing portion 95 that decreases the gap width toward the downward side is formed between the tapered face and the inner circumference of the sleeve encircling portion 27b of the housing 27. In the sealing portion 95, force is applied to, by a capillary phenomenon, the lubricant 92 toward the downward side at which the gap width decreases, and thus the lubricant 92 is held in the sealing portion 95. That is, the sealing portion 95 serves as a capillary seal. Note that the tapered face that forms the sealing portion 95 which decreases the gap width toward the downward side may be formed on the inner circumference of the sleeve encircling portion 27b of the housing 27.

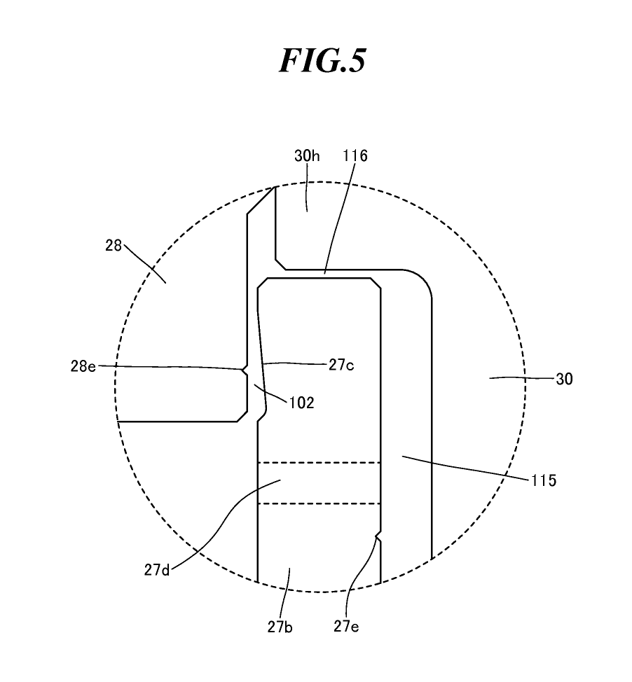

FIG. 5 is an enlarged diagram illustrating an example structure including a tapered gap 102 provided above the second gas-liquid interface 94.

A fifth gap 115 which is in communication with the retaining gap 91 and the sealing portion 95 is formed between the outer circumference of the sleeve 30 and the inner circumference of the sleeve encircling portion 27b of the housing 27. In addition, the sleeve 30 includes an annular portion 30h that protrudes annularly and outwardly in the radial direction, and a sixth gap 116 is formed between the lower face of the annular portion 30h and the upper face of the sleeve encircling portion 27b of the housing 27.

The upper end portion of the sleeve encircling portion 27b of the housing 27 is encircled by the hub 28, and has, a part of the outer circumference facing the hub 28, a tapered face 27c that increases the radius toward the downward side in the axial direction. According to such a structure, the tapered gap 102 that decreases the gap width toward the upper side in the axial direction is formed at a portion where the outer circumference of the sleeve encircling portion 27b of the housing 27 faces the inner circumference of the hub 28 in the radial direction. The tapered gap 102 is a space that is in communication with the sealing portion 95 which seals the lubricant 92 between the sleeve 30 and the housing 27, and in this space, the tapered gap 102 is formed so as to decrease the gap width toward the sealing portion 95.

According to this structure, even if, for example, the lubricant 92 is dispersed to and reaches the tapered gap 102, force is applied to, by a capillary phenomenon, the lubricant 92 toward the upper side at which the gap width is reduced, and thus the lubricant 92 is held in the tapered gap 102.

In addition, the fifth and sixth gaps 115, 116, and the tapered gap 102 form a bent labyrinth that is in communication with the retaining gap 91 unillustrated in FIG. 5 and the sealing portion 95. The labyrinth formed in this way further suppresses a dispersion of the lubricant 92 to the disk retaining space 24.

An annular recess 27e around the rotation axis R is formed in the inner circumference of the sleeve encircling portion 27b of the housing 27. In addition, an annular recess 28e around the rotation axis R is formed in the inner circumference of the hub 28 that forms the tapered gap 102. The recesses 27e, 28e hold the lubricant 92 which is dispersed from the second gas-liquid interface 94 and sticks to those recesses, thereby preventing the lubricant 92 from dispersing to the disk retaining space 24 through the fifth gap 115, the sixth gap 116, and the tapered gap 102. Needless to say, the location, the number, and the depth of the recess are not limited to the examples in this embodiment. The recess may be also formed in the outer circumference of the sleeve 30, the lower face of the annular portion 30h of the sleeve 30, and the upper face and outer circumference of the sleeve encircling portion 27b of the housing 27, etc.

A through-hole 27d is provided in the sleeve encircling portion 27b of the housing 27. The through-hole 27d causes the sealing portion 95 and the fifth gap 115 to be in communication with the outer circumferential space of the sleeve encircling portion 27b of the housing 27. Hence, pressure applied to the lubricant 92 can be reduced, thereby enabling the retaining gap 91 to further stably retain therein the lubricant 92.

According to the above-explained structure, the lubricant 92 is prevented from dispersing to the disk retaining space 24 by the sealing portion 95, the labyrinth formed from the fifth gap 115 to the tapered gap 102, the sealing function of the tapered gap 102, and the recesses 27e, 28e, etc.

As explained above, according to the rotating device 100 of the first embodiment, a dispersion of the lubricant 92 to the disk retaining space 24 can be suppressed, and the occurrence of an operation failure due to the lubricant 92 sticking to the recording disks 8 can be suppressed.

### Second Embodiment

Next, an explanation will be given of a second embodiment of the present disclosure with reference to the figures. The explanation for the same structural component as that of the already-explained embodiment will be omitted occasionally.

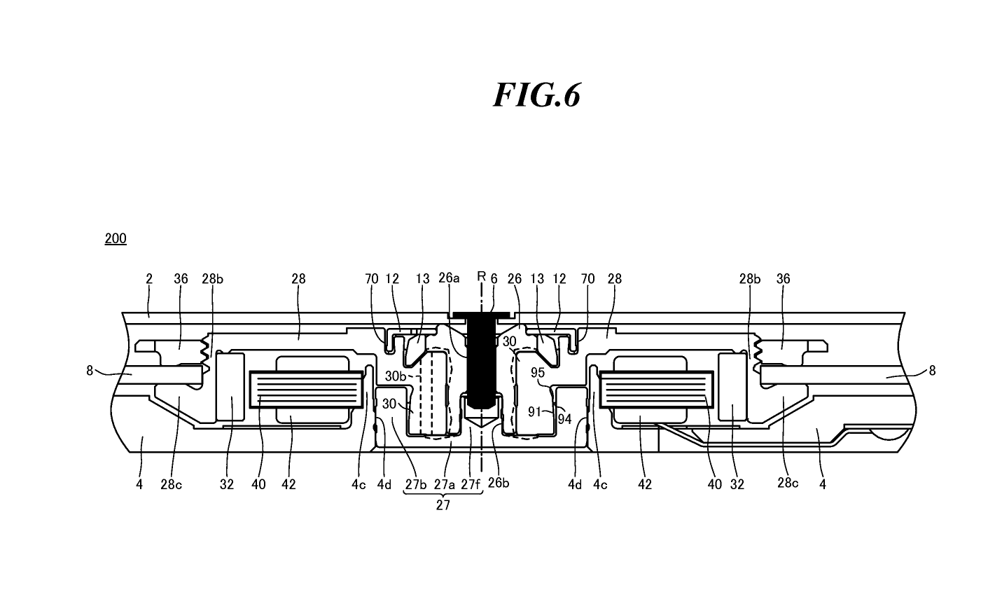

FIG. 6 is a cross-sectional view illustrating an example bearing mechanism of a rotating device 200 according to the second embodiment. The rotating device 200 exemplified in FIG. 6 is a thin disk drive device which has a 2.5-inch recording disk 8 to be loaded therein, and which has a thickness of, for example, 5 mm in the axial direction.

The rotating device 200 includes, as the stationary body components, the base 4, the cap 12, the top flange 13, the shaft 26, the housing 27, the stator core 40, and the coils 42. In addition, the rotating device 200 includes, as the rotating body components, the hub 28, the magnet 32, and the clamper 36.

In the rotating device 200, the lubricant 92 is applied to the gaps among the hub 28, the top flange 13, the shaft 26, and the housing 27, and the rotating body that includes the hub 28 on which the recording disk 8 is to be mounted is supported in a freely rotatable manner around the rotation axis R relative to the stationary body that includes the shaft 26.

The hub 28 is formed integrally with the sleeve 30 that encircles the shaft 26 as a single component. In addition, a male screw thread is provided on the outer circumference of the engage portion 28b of the hub 28. The clamper 36 has a female screw thread provided in the center hole, and this female screw thread is engaged with the male screw thread of the engage portion 28b, thereby fixing the recording disk 8 between the clamper 36 and the mount portion 28c.

The shaft 26 is formed in a substantially cylindrical shape, and is formed with the fastener screw hole 26a that passes through the shaft 26 from the top end to the bottom end along the rotation axis R. In addition, a recess 26b to be engaged with a protrusion 27f that protrudes cylindrically from the supporting portion 27a of the housing is provided in the lower end portion of the shaft 26.

The shaft 26 has the recess 26b engaged with and fixed to the protrusion 27f of the housing 27 by, for example, press-fitting, bonding or a combination thereof. In addition, the shaft 26 is fixed by the fastener screw 6 which is inserted from the top of the top cover 2, passes through the fastener screw hole 26a, and reaches the protrusion 27f of the housing 27.

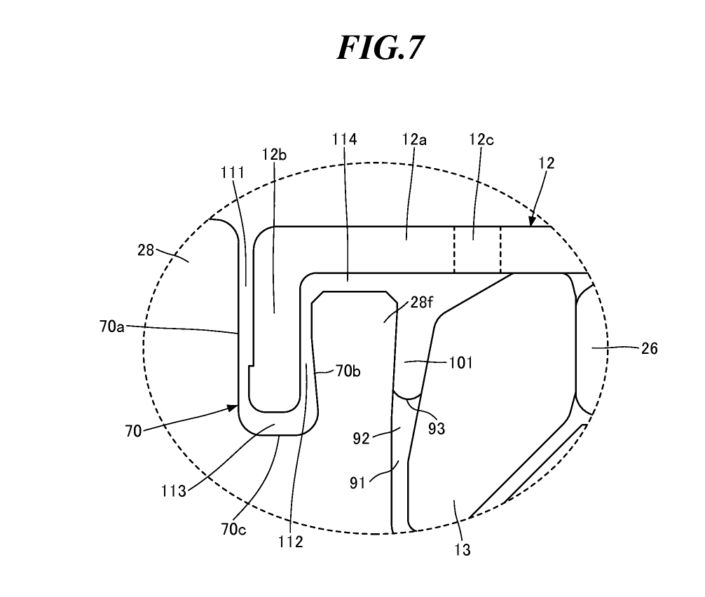

FIG. 7 is an enlarged diagram illustrating an example structure that includes the first gas-liquid interface 93 of the lubricant 92 according to the second embodiment.

As illustrated in FIG. 7, the lubricant 92 is retained in the retaining gap 91 formed between the top flange 13 and the hub 28. The hub 28 includes a cylindrical-portion encircling portion 28f that encircles the cylindrical portion 12b of the cap 12 so as to also encircle the top flange 13, and the first gas-liquid interface 93 of the lubricant 92 is formed between the inner circumference of the cylindrical-portion encircling portion 28f and the outer circumference of the top flange 13.

The top flange 13 has a tapered face which increases the radius toward the downward side in the axial direction and which is formed on the outer circumference of the top flange 13, and, a tapered space 101 which is in communication with the retaining gap 91, and which decreases the gap width toward the retaining gap 91 (toward the downward side in the axial direction) is formed between the tapered face and the inner circumference of the cylindrical-portion encircling portion 28f of the hub 28.

In the tapered space 101, force is applied to, by a capillary phenomenon, the lubricant 92 toward the downward side at which the gap width decreases. Hence, the lubricant 92 is held between the top flange 13 and the cylindrical-portion encircling portion 28f of the hub 28. That is, the tapered space 101 functions as a capillary seal.

As illustrated in FIG. 6, the annular cap 12 that covers the gap between the top flange 13 and the hub 28 is provided at the upper end portion of the shaft 26. The cap 12 has a center hole into which the upper end portion of the shaft 26 is inserted, and has the lower face provided so as to contact the upper face of the top flange 13. The cap 12 is fixed to the shaft 26 and the top flange 13 by, for example, press-fitting, bonding or a combination thereof.

As illustrated in FIG. 7, the cap 12 includes the annular cover portion 12a that covers the tapered space 101, and the cylindrical portion 12b that extends downwardly from the outer circumference of the cover portion 12a.

The annular groove 70 where the cylindrical portion 12b of the cap 12 enters is provided in the upper face of the hub 28. In the annular groove 70, a bent labyrinth that is in communication with the tapered space 101 is formed by the first gap 111, the second gap 112, and the third gap 113 which are formed between the annular groove 70 and the cylindrical portion 12b of the cap 12.

The cylindrical-portion encircling portion 28f of the hub 28 has a tapered face which increases the radius toward the upper side in the axial direction, and which is formed on the outer circumference, and thus the second gap 112 is formed so as to decrease the gap width toward the upper side. According to this structure, even if, for example, the lubricant 92 is dispersed to the second gap 112, force is applied to, by a capillary phenomenon, the lubricant 92 toward the upper side at which the gap width decreases, and thus the lubricant 92 is held in the second gap 112.

According to the above-explained structure, the lubricant 92 is prevented from being dispersed to the disk retaining space 24 by the tapered space 101, the labyrinth formed from the first gap 111 to the third gap 112, and the sealing function of the second gap 112.

A tapered face that increases the width of the fourth gap 114 outwardly in the radial direction may be formed on the lower face of the cap 12 or the upper face of the cylindrical-portion encircling portion 28f of the hub 28. According to this structure, the fourth gap 114 can hold, by a capillary phenomenon, the dispersed lubricant 92.

The cylindrical portion 12b of the cap 12 may be formed so as to be inclined relative to the axial direction and to increase the radius toward the downward side. According to this structure, the first gap 111 decreases the gap width toward the downward side in the axial direction, and thus the dispersed lubricant 92 can be held in the first gap 111 by a capillary phenomenon.

In addition, an annular recess around the rotation axis R may be further formed in, for example, the lower face of the cover portion 12a of the cap 12, the inner circumference and outer circumference of the cylindrical portion 12b, and, the first wall 70a, the second wall 70b, and the bottom wall 70c of the annular groove 70. The recess holds the lubricant 92 dispersed from the first gas-liquid interface 93 and sticking to the recess, and prevents the lubricant 92 from dispersing to the disk retaining space 24 through the fourth gap 114 to the first gap 111.

As explained above, according to the rotating device 200 of the second embodiment, the lubricant 92 is prevented from dispersing to the disk retaining space 24, and thus an occurrence of an operation failure caused by the lubricant 92 sticking to the recording disk 8 can be reduced.

Rotating devices according to the embodiments of the present disclosure were explained, but the present disclosure is not limited to the above-explained embodiments, and various modifications and improvements can be made within the scope of the present disclosure.

What is claimed is:

1. A rotating device comprising:
a stationary body;
a rotating body that is supported in a freely rotatable manner relative to the stationary body;
a retaining gap that retains a lubricant between the stationary body and the rotating body;
a fluid dynamic pressure generating portion that generates dynamic pressure to the fluid in the retaining gap;
a capillary seal which is in communication with a first end of the retaining gap, and which extends toward an external side from the retaining gap;
a cap provided on the stationary body, the cap comprising an annular cover portion that covers at least a part of an end of the capillary seal which is located at the external side from the retaining gap, and, a cylindrical portion that extends from an outer circumference of the cover portion in an axial direction which is in parallel with a rotation axis of the rotating body; and
an annular groove provided in the rotating body, the annular groove comprising an annular first wall that encircles the cylindrical portion via a first gap, an annular second wall that is encircled by the cylindrical portion via a second gap, and a bottom wall that faces, via a third gap in the axial direction, an end of the cylindrical portion opposite to the cover portion.

2. The rotating device according to claim 1, wherein the first gap, the second gap, and the third gap are in communication with each other, and form a bent labyrinth.

3. The rotating device according to claim 1, wherein the first gap decreases a gap width toward the bottom wall in the axial direction.

4. The rotating device according to claim 1, wherein the second gap decreases a gap width toward an opposite side to the bottom wall in the axial direction.

5. The rotating device according to claim 1, wherein:
a fourth gap is formed between the cover portion and the rotating body in the axial direction; and
the fourth gap decreases a gap width toward the rotation axis.

6. The rotating device according to claim 1, wherein:
the rotating body comprises a sleeve, and a hub which is coupled with the sleeve and which has an outer circumference on which a recording disk is to be mounted;
the stationary body comprises a shaft that is encircled by the sleeve via a gap which is a part of the retaining gap, and a housing that includes an encircling portion encircling a portion of the sleeve opposite to a portion coupled with the hub; and
the rotating device further comprises:
a second capillary seal that is in communication with a second end of the retaining gap; and
a tapered gap which is formed between an inner circumference of the hub and an outer circumference of the encircling portion, is in communication with the second capillary seal, and decreases a gap width toward the second capillary seal.

7. The rotating device according to claim 1, wherein the rotating body comprises a portion provided with the first wall, and a portion provided with the second wall.

8. The rotating device according to claim 1, wherein the cap is provided with a through-hole formed in the cover portion.

9. The rotating device according to claim 1, wherein at least one of the cap, the first wall, and the second wall is provided with an annular recess around the rotation axis.

10. The rotating device according to claim 1, wherein an oil repellent agent is applied to at least a part of the cap facing with the capillary seal.

11. A rotating device comprising:
a stationary body;
a rotating body that is supported in a freely rotatable manner relative to the stationary body;
a retaining gap that retains a lubricant between the stationary body and the rotating body;
a fluid dynamic pressure generating portion that generates dynamic pressure to the fluid in the retaining gap;
a capillary seal which is in communication with a first end of the retaining gap, and which extends toward an external side from the retaining gap; and
a cap provided on the stationary body, the cap comprising an annular cover portion that covers at least a part of an end of the capillary seal which is located at the external side from the retaining gap, and, a cylindrical portion that extends from an outer circumference of the cover portion in an axial direction which is in parallel with a rotation axis of the rotating body,
wherein:
the rotating body comprises an annular first wall that encircles the cylindrical portion via a first gap, an annular second wall that is encircled by the cylindrical portion via a second gap, and a bottom wall that faces, via a third gap in the axial direction, an end of the cylindrical portion opposite to the cover portion; and
the first gap, the second gap, and the third gap are in communication with each other, and form a bent labyrinth.

12. The rotating device according to claim 11, wherein the first gap decreases a gap width toward the bottom wall in the axial direction.

13. The rotating device according to claim 11, wherein the second gap decreases a gap width toward an opposite side to the bottom wall in the axial direction.

14. The rotating device according to claim 11, wherein:
a fourth gap is formed between the cover portion and the rotating body in the axial direction; and
the fourth gap decreases a gap width toward the rotation axis.

15. The rotating device according to claim 11, wherein the cap is provided with a through-hole formed in the cover portion.

16. The rotating device according to claim 11, wherein at least one of the cap, the first wall, and the second wall is provided with an annular recess around the rotation axis.

17. A rotating device comprising:
a stationary body;
a rotating body that is supported in a freely rotatable manner relative to the stationary body;
a retaining gap that retains a lubricant between the stationary body and the rotating body;
a fluid dynamic pressure generating portion that generates dynamic pressure to the fluid in the retaining gap;
a capillary seal which is in communication with a first end of the retaining gap, and which extends toward an external side from the retaining gap; and
a cap provided on the stationary body, the cap comprising an annular cover portion that covers at least a part of an end of the capillary seal which is located at the external side from the retaining gap, and, a cylindrical portion that extends from an outer circumference of the cover portion in an axial direction which is in parallel with a rotation axis of the rotating body,
wherein:
the rotating body comprises an annular first wall that encircles the cylindrical portion via a first gap, an annular second wall that is encircled by the cylindrical portion via a second gap, and a bottom wall that faces, via a third gap in the axial direction, an end of the cylindrical portion opposite to the cover portion;
the first gap decreases a gap width toward the bottom wall in the axial direction; and
the second gap decreases a gap width toward an opposite side to the bottom wall in the axial direction.

18. The rotating device according to claim 17, wherein the first gap, the second gap, and the third gap are in communication with each other, and form a bent labyrinth.

19. The rotating device according to claim 17, wherein the cap is provided with a through-hole formed in the cover portion.

20. The rotating device according to claim 17, wherein at least one of the cap, the first wall, and the second wall is provided with an annular recess around the rotation axis.
